(19) United States
(12) Patent Application Publication
(10) Pub. No.: US 2022/0388461 A1
(43) Pub. Date: Dec. 8, 2022

(54) WIRING MEMBER

(71) Applicant: Sumitomo Wiring Systems, Ltd., Mie (JP)

(72) Inventors: Ryusuke KUDO, Mie (JP); Tetsuya NISHIMURA, Mie (JP); Haruka NAKANO, Mie (JP); Masaki MIZUSHITA, Mie (JP); Kenta ARAI, Mie (JP)

(73) Assignee: Sumitomo Wiring Systems, Ltd., Mie (JP)

(21) Appl. No.: 17/774,299

(22) PCT Filed: Oct. 27, 2020
(86) PCT No.: PCT/JP2020/040161

§ 371 Date: May 4, 2022

(30) Foreign Application Priority Data
Nov. 14, 2019 (JP) 2019-206158

(51) Int. Cl. B60R 16/02; H02G 3/04; F16B 5/06; F16B 19/00

(52) U.S. Cl. CPC B60R 16/0215; H02G 3/04; F16B 5/0621; F16B 19/004

(57) ABSTRACT

A wiring member is a wiring member including: a wire-like transmission member; a first sheet to which the wire-like transmission member is fixed; and a second sheet, at least a part of which is overlapped with the first sheet, wherein the second sheet has higher rigidness than the first sheet, a holding hole is formed in the second sheet, and the second sheet is held on a fixing target member of a vehicle via a vehicle fixing component inserted into the holding hole.

### TECHNICAL FIELD

The present disclosure relates to a wiring member.

### BACKGROUND ART

Patent Document 1 discloses that a wiring module is fixed to a fixing target member via an adhesive part.

### PRIOR ART DOCUMENTS

### Patent Documents

Patent Document 1: Japanese Patent Application Laid-Open No. 2018-196096

### SUMMARY

### Problem to be Solved by the Invention

Desired is that a wiring member can be fixed to a fixing target member more firmly.

Accordingly, an object of the present disclosure is to fix a wiring member to a fixing target member more firmly.

### Means to Solve the Problem

A wiring member according to the present disclosure is a wiring member including: a wire-like transmission member; a first sheet to which the wire-like transmission member is fixed; and a second sheet, at least a part of which is overlapped with the first sheet, wherein the second sheet has higher rigidity than the first sheet, at least one holding hole is formed in the second sheet, and the second sheet is held on a fixing target member of a vehicle via a vehicle fixing component inserted into the holding hole.

### Effects of the Invention

According to the present disclosure, the wiring member is fixed to the fixing target member more firmly.

### BRIEF DESCRIPTION OF DRAWINGS

FIG. 1 is a plan view illustrating a wiring member according to an embodiment.

FIG. 2 is a II-II line cross-sectional view in FIG. 1.

FIG. 3 is an explanation diagram illustrating a movable amount according to a first modification example.

FIG. 4 is a cross-sectional view illustrating a wiring member according to a second modification example.

FIG. 5 is a plan view illustrating a wiring member according to a third modification example.

FIG. 6 is a cross-sectional view illustrating a wiring member according to a fourth modification example.

### DESCRIPTION OF EMBODIMENT(S)

### Description of Embodiment of Present Disclosure

Embodiments of the present disclosure are listed and described firstly.

A wiring member according to the present disclosure is as follows.

(1) A wiring member includes: a wire-like transmission member; a first sheet to which the wire-like transmission member is fixed; and a second sheet, at least a part of which is overlapped with the first sheet, wherein the second sheet has higher rigidity than the first sheet, at least one holding hole is formed in the second sheet, and the second sheet is held on a fixing target member of a vehicle via a vehicle fixing component inserted into the holding hole.

According to this wiring member, the vehicle fixing component is held in the second sheet while being inserted into the holding hole of the second sheet having higher rigidity than the first sheet. The wiring member is held on the fixing target member of the vehicle via the vehicle fixing component inserted into the holding hole formed in the second sheet, thus a positional deviation of the fixed wiring member can be suppressed, and the wiring member can be firmly fixed.

(2) In the wiring member according to (1), the holding hole may be provided in a position away from the wire-like transmission member.

(3) It is applicable that in the wiring member according to (1) or (2), at least the second sheet includes a protruding piece protruding to a lateral side with respect to a portion of the first sheet to which the wire-like transmission member is fixed, and the holding hole is formed in the protruding piece. In this case, a part of the wiring member other than a portion where the protruding piece is formed can be formed to have a small width. The part of the wiring member other than the portion where the protruding piece is formed is formed to have a small width, thus the fixing target member can be visually recognized at a time of fixing a vehicle fixing component to the fixing target member. Thus, an operation of fixing the vehicle fixing component to the fixing target member can be easily performed.

(4) It is also applicable that in the wiring member according to (1) or (2), the first sheet includes a band-like portion to which the wire-like transmission member is fixed, and the holding hole is formed in a part of the second sheet overlapped with the band-like portion. Accordingly, a portion partially protruding to a lateral side from the wiring member hardly occurs.

(5) It is also applicable that in the wiring member according to any one of (1) to (4), the holding hole is formed in a portion of the second sheet overlapped with the first sheet, an overlap holding hole is formed in a region of the first sheet overlapped with a forming region where the holding hole is formed, and the vehicle fixing component is inserted into both the holding hole and the overlap holding hole. Accordingly, the vehicle fixing component is held in the first sheet and the second sheet more firmly.

(6) It is also applicable that in the wiring member according to any one of (1) to (5), the plurality of holding holes are formed in the second sheet, and the plurality of holding holes may include holding holes alternately formed on both sides of the wire-like transmission member. The plurality of holding holes include holding holes alternately formed on both sides of the wire-like transmission member, thus both side portions of the wiring member is fixed to a fixing target member at alternate positions. Accordingly, the wiring member can be stably fixed to the fixing target member.

(7) It is also applicable that the wiring member according to any one of (1) to (6), the vehicle fixing member includes a head part extending more than the holding hole, and the head part has contact with the second sheet while the vehicle fixing component is fixed to the fixing target member. In this case, the head part presses the second sheet while having contact with the second sheet. Thus, the wiring member is firmly fixed to the fixing target member.

(8) It is also applicable that in the wiring member according to any one of (1) to (7), wherein the vehicle fixing component includes an elongated columnar part and a plurality of locking pieces having a cone-shaped outer peripheral surface, each of which can be caught in a hole formed in the fixing target member, and the plurality of locking pieces are formed at intervals along a longitudinal direction of the columnar part. Accordingly, any of the plurality of locking pieces is caught in an edge of the holding hole while the vehicle fixing component is inserted into the holding hole, and a state where the vehicle fixing component comes out of the holding hole can be suppressed. Thus, the vehicle fixing component and the second sheet can be handled integrally and easily.

(9) It is also applicable that in the wiring member according to any one of (1) to (8), the vehicle fixing component includes an additional holding part fixing an additional wire-like transmission member. Accordingly, the vehicle fixing component can fix the additional wire-like transmission member using the additional holding part in addition to the wire-like transmission member fixed to the first sheet.

(10) It is also applicable that in the wiring member according to any one of (1) to (9) further includes a third sheet fixed to an opposite side of the first sheet from the second sheet, and the third sheet has higher rigidity than the first sheet. Accordingly, even if the fixing target member interferes with the first sheet after the wiring member is fixed to the vehicle, the wiring member can be reinforced by the third sheet.

(11) It is also applicable that in the wiring member according to (10), the holding hole is formed in a portion of the second sheet overlapped with the third sheet, and an overlap holding hole is formed in a region of the third sheet overlapped with a forming region where the holding hole is formed. Rigidity is increased by overlapping the third sheet on the second sheet. Accordingly, more firm fixation can be achieved.

(12) It is also applicable that in the wiring member according to (10) or (11), the third sheet is formed of the same material as a material of the second sheet. A configuration of forming the first sheet and the second sheet by the same material contributes to cost reduction.

(13) It is also applicable that in the wiring member according to any one of (1) to (12), the holding hole includes a first holding hole and a second holding hole, and a movable amount of the vehicle fixing component in the first holding hole and a movable amount of the vehicle fixing component in the second holding hole is different from each other in a plane which the second sheet spreads. For example, the vehicle fixing component held in a holding hole in which the movable amount is smaller in the first holding hole and the second holding hole can fix the wiring member to the fixing target member at a given position as much as possible. The vehicle fixing component held in the holding hole in which the movable amount is larger in the first holding hole and the second holding hole can fix the wiring member to the fixing target member while absorbing an error.

### Details of Embodiment of Present Disclosure

Specific examples of a wiring member of the present disclosure are described hereinafter with reference to the drawings. The present disclosure is not limited to these examples, but is indicated by claims, and it is intended that meanings equivalent to claims and all modifications within a scope of claims are included.

### Embodiment

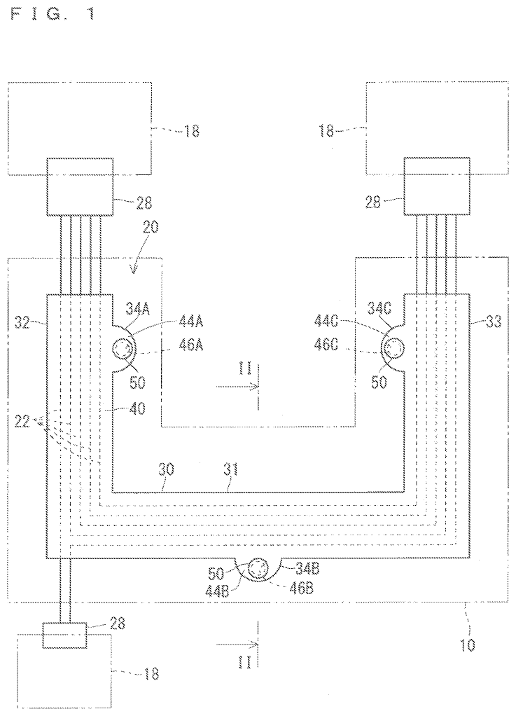

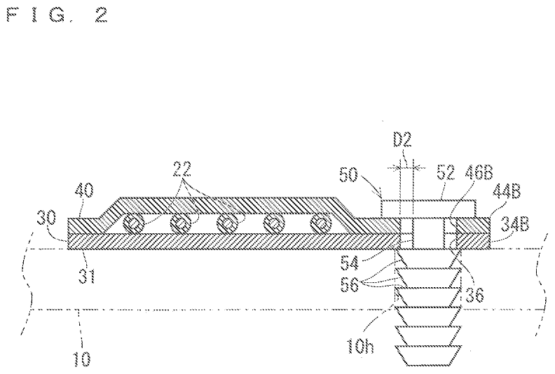

A wiring member according to an embodiment is described hereinafter. FIG. 1 is a plan view illustrating a wiring member 20 according to the embodiment. FIG. 2 is a II-II line cross-sectional view in FIG. 1. In FIG. 1 and FIG. 2, the fixing target member 10 to which the wiring member 20 is fixed is indicated by a virtual line.

The wiring member 20 is a wiring component fixed to the fixing target member 10. The fixing target member 10 is assumed to be various types of component in a vehicle such as a body and an interior panel, for example. A material of the fixing target member 10 is not be particularly limited, thus metal or resin is also applicable.

The wiring member 20 includes a wire-like transmission member 22, a first sheet 30, and a second sheet 40.

The wire-like transmission member 22 is assumed to be a wire-like transmission member connecting components in a vehicle. A wiring member 20 includes the plurality of wire-like transmission members 22. The wire-like transmission members 22 are branched in accordance with positions of component to which the plurality of wire-like transmission members 22 are connected, and extend along a wiring route in a vehicle.

More specifically, the wire-like transmission member 22 may be a wire-like member transmitting an electrical power or light, for example. For example, the wire-like transmission member 22 may be a general wire having a core wire and a covering around the core wire, or may also be a bare wire, a shielded wire, a twisted wire, an enamel wire, a nichrome wire, or an optical fiber.

The wire-like transmission member 22 transmitting the electrical power may be various kinds of signal lines or various kinds of power lines. Some of the wire-like transmission members transmitting the electrical power may be used as an antenna or coil, for example, transmitting or receiving a signal or electrical power to or from a space.

The wire-like transmission member 22 may be a single wire-like object or a composite object of a plurality of wire-like objects (a twisted wire and a cable made up of a plurality of wire-like objects covered by a sheath).

Description herein is based on an assumption that the wire-like transmission member 22 is an electrical wire 22.

The first sheet 30 is a sheet-like member to which the electrical wire 22 is fixed. The first sheet 30 is formed into an elongated sheet-like shape extending along a wiring route. Herein, the first sheet 30 includes an intermediate portion 31, one end portion 32, and the other end portion 33. Each of the intermediate portion 31 and the end portion 32 and 33 is formed into an elongated band-like shape. One end portion 32 extends from one end portion of the intermediate portion 31 in a direction intersecting with an extension direction of the intermediate portion 31 (herein, a direction perpendicular to the extension direction thereof). The other end portion 33 extends from the other end portion of the intermediate portion 31 in a direction intersecting with an extension direction of the intermediate portion 31 (herein, a direction perpendicular to the extension direction thereof). Herein, the direction in which one end portion 32 and the other end portion 33 extend from the intermediate portion 31 is the same.

The first sheet 30 may be linearly formed, or may also be bended in various directions. The first sheet 30 may have a portion bended to have a curved shape. The first sheet 30 may have a branched portion.

Applicable as the fixing state of fixing the electrical wire 22 to the first sheet 30 are a contact area fixation and a non-contact area fixation, or both fixations may be used together. Herein, the contact area fixation indicates that a portion where the electrical wire 22 and the first sheet 30 have contact with each other is stuck and fixed. The non-contact area fixation indicates the fixing state which is not the contact area fixation. The non-contact area fixation indicates that a fixing member such as a sewing thread, the other sheet material, or an adhesive tape, for example, presses the electrical wire 22 toward the first sheet 30 or sandwiches the electrical wire 22 and the first sheet 30 to keep them in a fixing state. In the description hereinafter, the electrical wire 22 and the first sheet 30 are in the state of the contact area fixation.

Applicable as the configuration of the contact area fixation are a contact area indirect fixation and a contact area direct fixation, or both fixations may also be used together in different regions. Herein, the contact area indirect fixation indicates that the electrical wire 22 and the first sheet 30 are indirectly stuck and fixed via an adhesive agent, a gluing agent, and a double-sided adhesive tape provided therebetween. The contact area direct fixation indicates that the electrical wire 22 and the first sheet 30 are directly stuck and fixed without an intervention of the adhesive agent, for example, which is separately provided. Considered in the contact area direct fixation is that resin included in at least one of the electrical wire 22 and the first sheet 30 is melted, thus the electrical wire 22 and the first sheet 30 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as welding, fusion, and melting joint can be used. For example, when the state of the contact area direct fixation by the heat is formed by welding, various welding means such as ultrasonic welding, heating-pressurizing welding, hot air welding, and high frequency welding can be adopted. When the state of the contact area direct fixation is formed by these means, the electrical wire 22 and the first sheet are in the state of the contact area direct fixation by these means. Specifically, when the state of the contact area direct fixation is formed by the ultrasonic welding, for example, the electrical wire 22 and the first sheet 30 are in the state of the contact area direct fixation by the ultrasonic welding.

In the description hereinafter, the electrical wire 22 and the first sheet 30 are in the state of the contact area direct fixation.

Herein, the plurality of electrical wires 22 are fixed to one main surface of the first sheet 30 to parallelly extend along the extension direction of the first sheet 30. The plurality of electrical wires 22 extend from an end portion of the first sheet 30 to an outer side, and are connected to a connector 28. The plurality of electrical wires 22 may not extend from the end portion of the first sheet 30. For example, it is also applicable that a connector is fixed to the end portion of the first sheet 30 and the plurality of electrical wires 22 do not extend from the first sheet 30 but are connected to the connector.

Some of the electrical wires 22 in the plurality of electrical wires 22 may be branched from the other electrical wires 22 in an intermediate portion of the first sheet 30 in the extension direction to extend from a lateral side of the first sheet 30 to an outer side. Herein, some of the electrical wires 22 are branched from the other electrical wires 22 between the intermediate portion 31 and the end portion 32 to extend to an outer side. The connector 28 is also connected to end portions of some of the electrical wires 22 which are branched.

The electrical wire 22 is connected to a component 18 (an electrical component 18 herein) in a vehicle via the connector 28. The electrical wire 22 may be directly connected to the electrical component 18 without an intervention of the connector 28.

The second sheet 40 is a sheet, at least a part of which is overlapped with the first sheet 30. Herein, the second sheet 40 is formed into the same shape as the first sheet 30, and is overlapped with a whole of the first sheet 30. The second sheet 40 may be overlapped with a part of the first sheet 30 in the extension direction. The second sheet 40 may be overlapped with a part of the first sheet 30 in a width direction.

The second sheet 40 may be overlapped with a surface of the first sheet 30 on a side which the electrical wire 22 is fixed or may also be overlapped with a surface thereof on a side which the electrical wire 22 is not fixed. The second sheet 40 may also be overlapped with both surfaces of the first sheet 30.

When the second sheet 40 is overlapped with the first sheet 30 on the side which the electrical wire 22 is fixed, the second sheet 40 can have a function of protecting the electrical wire 22. The second sheet 40 can have a function of making the wiring member 20 be hardly bended. When the second sheet 40 is overlapped with the first sheet 30 on a side opposite to a side which the electrical wire 22 is fixed, the second sheet 40 can have a function of reinforcing the first sheet 30 from a back side and making the electrical wire 22 be hardly bended as a whole. The second sheet 40 may be overlapped with the first sheet 30 only in a region where holding holes 46A, 46B, and 46C described hereinafter are formed. It is not necessary that the second sheet 40 has the functions described above. Described herein is an example that the second sheet 40 is overlapped with a surface of the first sheet 30 on a side which the electrical wire 22 is fixed. That is to say, the second sheet 40 is overlapped with the first sheet 30 while covering the electrical wire 22. The first sheet 30 and the second sheet 40 are mutually fixed on both outer sides of the electrical wire 22 fixed to the first sheet 30. These sheets may be fixed by welding, bonding, adhesion, or sewing, for example. The welding may be ultrasonic welding or thermal welding.

A material constituting the first sheet 30 and the second sheet 40 is not particularly limited. For example, the first sheet 30 and the second sheet 40 may be formed of resin such as polyvinyl chloride (PVC), polyethylene terephthalate (PET), polypropylene (PP), or nylon. The first sheet 30 and the second sheet 40 may be a fibrous material having fiber such as a non-woven cloth, a woven fabric, or a knitting fabric or a non-fiber material, for example. The non-fiber material may be a solid member with an inner portion evenly filled or a foam made up by foam molded resin. The first sheet 30 and the second sheet 40 may contain a material such as metal, for example.

The second sheet 40 has higher rigidity than the first sheet 30. Herein, the rigidity indicates a degree of difficulty in deformation by external force. For example, the first sheet 30 may be soft enough to be able to be bended, particularly soft enough to be able to be folded. For example, the second sheet 40 may have rigidity high enough to allow the wiring member 20 to keep a constant wiring route as much as possible. A difference of rigidity between the first sheet 30 and the second sheet 40 can be achieved by one of a difference between the material constituting the first sheet 30 and the material constituting the second sheet 40, a difference between an outer shape of the first sheet 30 and an outer shape of the second sheet 40, and a difference of an inner shape of the first sheet 30 and an inner shape of the second sheet 40 or a combination thereof. For example, it is applicable that the material constituting the second sheet 40 is harder than the material constituting the first sheet 30, thus the second sheet 40 is formed to have higher rigidity than the first sheet 30. More specifically, the first sheet 30 may be mainly formed of soft polyvinyl chloride (PVC), and the second sheet 40 may be mainly formed of hard PVC. For example, it is applicable that a thickness of the second sheet 40 is larger than a thickness of the first sheet 30, thus the second sheet 40 is formed to have higher rigidity than the first sheet 30. For example, it is applicable that the first sheet 30 is a non-woven sheet, and the second sheet 40 is a sheet with an inner portion evenly filled, thus the second sheet 40 is formed to have higher rigidity than the first sheet 30. Furthermore, it is applicable that the first sheet 30 is a stacked sheet made up of a non-woven sheet and a soft PVC sheet, and the second sheet 40 is a hard PVC sheet, thus the second sheet 40 is formed to have higher rigidity than the first sheet 30. It goes without saying that the first sheet and the second sheet may have different thickness so that rigidity thereof are made different.

The second sheet 40 is a portion held on the fixing target member 10 via the vehicle fixing component 50 inserted into the holding holes 46A, 46B, and 46C. The vehicle fixing component 50 is a component which can be fixed to the fixing target member 10 in a vehicle. Herein, a vehicle-side fixing hole 10h is formed in the fixing target member 10. The vehicle-side fixing hole 10h may be a circular hole or an oval hole. Herein, the fixing target member 10 includes a plate-like portion. The vehicle-side fixing hole 10h is a hole formed to pass through the plate-like portion from a front side to a back side.

The vehicle fixing component 50 may be a component referred to as a clip or a clamp used for fixing various vehicle components such as a wire harness to a vehicle. Herein, the vehicle fixing component 50 is a component formed of integrally molded resin, for example. The vehicle fixing component 50 includes a head part 52, a columnar part 54, and a plurality of locking pieces 56. The columnar part 54 is formed into an elongated shape. The columnar part 54 may be formed into a cylindrical shape or a rectangular columnar shape. The head part 52 is formed in a base end portion of the columnar part 54. The head part 52 is formed into a shape extending more than the holding holes 46A, 46B, and 46C described hereinafter, and does not come out of the holding holes 46A, 46B, and 46C but can be caught in a peripheral edge part of each of the holding holes 46A, 46B, and 46C in the second sheet 40. Herein, the head part 52 is formed into a circular plate-like shape. The head part 52 may be formed into a disc spring-like shape. Each of the plurality of locking pieces 56 are formed into a cone-shaped outer peripheral surface, in other words, a shape directed to a base end portion of the columnar part 54 with a decreasing distance to an outer peripheral side of the columnar part 54. An outer width of the locking piece 56 is larger than an inner diameter of the vehicle-side fixing hole 10h. Thus, the locking piece 56 can be caught in the vehicle-side fixing hole 10h formed in the fixing target member 10. The plurality of locking pieces 56 are formed to be arranged side by side at intervals along the longitudinal direction of the columnar part 54.

Then, when the vehicle fixing component 50 is inserted into the vehicle-side fixing hole 10h, outward inclined surfaces of the plurality of locking pieces 56 have contact with the peripheral edge part of the vehicle-side fixing hole 10h, and the locking pieces 56 can be elastically deformed to shrink to a side of the columnar part 54. When at least some of the plurality of locking pieces 56 come out of the vehicle-side fixing hole 10h, the locking pieces 56 are elastically restored to an original shape, thus can be caught in the peripheral edge part of the vehicle-side fixing hole 10h in a retaining state. Accordingly, the vehicle fixing component 50 is fixed to the fixing target member 10.

The vehicle fixing component 50 is held in the second sheet 40 by the following configuration.

That is to say, the holding holes 46A, 46B, and 46C are formed in the second sheet 40. The holding holes 46A, 46B, and 46C are provided in positions away from the electrical wire 22. Herein, the second sheet 40 includes protruding pieces 44A, 44B, and 44C protruding to a lateral side in relation to a portion of the first sheet 30 to which the electrical wire 22 is fixed.

More specifically, as described above, the first sheet 30 includes an intermediate portion 31 and end portions 32 and 33 extending along the route of the electrical wire 22. A portion of the first sheet 30 where the intermediate portion 31 and the end portions 32 and 33 are connected in a band-like form is a band-like portion of the first sheet 30 to which the electrical wire 22 is fixed.

The second sheet 40 includes band-like portions extending to the same region as the intermediate portion 31 and the end portions 32 and 33 in the first sheet 30. The protruding pieces 44A, 44B, and 44C are formed to protrude to an outer side from any lateral portion of the band-like portion.

A shape of each of the protruding pieces 44A, 44B, and 44C is not particularly limited. Herein, the protruding pieces 44A, 44B, and 44C are formed into a shape in which a tip end portion forms into an arch, more specifically, a semicircular shape. The protruding pieces 44A, 44B, and 44C may be formed into polygonal shape or a triangular shape, for example.

The holding holes 46A, 46B, and 46C are formed in the protruding pieces 44A, 44B, and 44C, respectively. Each of the holding holes 46A, 46B, and 46C are formed into a shape which the vehicle fixing component 50 described above can be inserted into and the head part 52 is caught in. For example, each of the holding holes 46A, 46B, and 46C is formed into a shape smaller than the head part 52. Accordingly, head part 52 does not come out of the holding holes 46A, 46B, and 46C but can be caught in the peripheral edge part of each of the holding holes 46A, 46B, and 46C. For example, each of the holding holes 46A, 46B, and 46C is formed to be larger than the columnar part 54 described above. Accordingly, the columnar part 54 can be inserted into the holding holes 46A, 46B, and 46C. Each of the holding holes 46A, 46B, and 46C is formed to be smaller than the locking piece 56. Accordingly, the locking piece 56 can be caught in the peripheral edge part of each of the holding holes 46A, 46B, and 46C while the columnar part 54 of the vehicle fixing component 50 is inserted into each of the holding holes 46A, 46B, and 46C, and the vehicle fixing component 50 hardly comes out from the first sheet 30. For example, the holding holes 46A, 46B, and 46C may be formed to have the same diameter as the vehicle-side fixing hole 10h described above.

Herein, the first sheet 30 also includes protruding pieces 34A, 34B, and 34C protruding to a region overlapped with the protruding pieces 44A, 44B, and 44C described above. The protruding pieces 44A, 44B, and 44C and the protruding pieces 34A, 34B, and 34C are overlapped with each other. The protruding pieces 44A, 44B, and 44C and the protruding pieces 34A, 34B, and 34C may be or may not be fixed to each other. The overlap holding hole 36 is also formed in the protruding pieces 44A, 44B, and 44C described above. The overlap holding hole 36 is formed in a region overlapped with the corresponding holding holes 46A, 46B, and 46C. In other words, the holding holes 46A, 46B, and 46C are formed in a portion of the second sheet 40 overlapped with the first sheet 30, and the overlap holding hole 36 is formed in a region overlapped with a forming region where the holding holes 46A, 46B, and 46C are formed in the first sheet 30.

The first sheet 30 may not include a portion overlapped with the protruding pieces 44A, 44B, and 44C.

The vehicle fixing component 50 is held in the second sheet 40 while being inserted into both the holding holes 46A, 46B, and 46C and the holding hole 36. The vehicle fixing component 50 is held by inserting at least the columnar part 54 described above into the holding holes 46A, 46B, and 46C. The vehicle fixing component 50 needs not be held in the second sheet 40 to an extent that the vehicle fixing component 50 is hardly separated from the second sheet 40. It is sufficient that the vehicle fixing component 50 is held to an extent that the vehicle fixing component 50 is kept in a constant position in the second sheet 40 in fixing the wiring member 20 to the fixing target member 10.

Herein, the peripheral edge parts of the holding holes 46A, 46B, and 46C in the first sheet 30 and the peripheral edge part of the overlap holding hole 36 in the second sheet 40 are disposed between some the plurality of locking pieces 56 or disposed between the head part 52 and the locking piece 56 located closest to the head part 52 while the vehicle fixing component 50 is inserted into the holding holes 46A, 46B, and 46C and the overlap holding hole 36. Accordingly, the vehicle fixing component 50 hardly comes out of the holding holes 46A, 46B, and 46C and the overlap holding hole 36, and the vehicle fixing component 50 is easily kept in a state of being held in the first sheet 30. The vehicle fixing component may be held in the first sheet more reliably by an adhesive agent or a gluing agent, for example. The vehicle fixing component may be held in the first sheet more reliably by the other locking structure.

The vehicle fixing component may have the other configuration as long as it can be held in the first sheet while being inserted into the holding hole formed in the first sheet, and can be fixed to the vehicle. For example, the vehicle fixing component may have a configuration in which a pair of locking pieces outwardly inclined from a tip end portion toward a base end portion of the columnar part extend. In this case, the holding hole is preferably formed to have a size so that the pair of locking pieces can be locked thereto. The vehicle fixing component 50 may be a screw. In this case, the holding hole is preferably formed to have a size so that a screw thread can be caught in the holding hole.

Herein, the vehicle fixing component 50 is inserted into the holding holes 46A, 46B, and 46C and the overlap holding hole 36 from the second sheet 40 toward the first sheet 30. Thus, the head part 52 is located on a side of the holding holes 46A, 46B, and 46C while the columnar part 54 is inserted into the holding holes 46A, 46B, and 46C and the overlap holding hole 36. The head part 52 can have contact with the second sheet 40 having higher rigidity. Thus, the head part 52 can press the wiring member 20 toward the fixing target member 10 via the second sheet 40 having higher rigidity.

The plurality of holding holes 46A, 46B, and 46C include the holding holes alternately formed on both sides of the electrical wire 22. Herein, the plurality of holding holes 46A, 46B, and 46C are alternately formed on both sides of the electrical wire 22.

More specifically, the protruding piece 44A is formed to protrude from an inward side of one end portion 32. The protruding piece 44C is formed to protrude from an inward side of the other end portion. The protruding piece 44C located between the protruding piece 44A and the protruding piece 44B is formed to protrude from an outward side of the intermediate portion 31 in a direction in which the electrical wire 22 extends (a direction in which a band-like portion extends). Thus, when the band-like portion of the second sheet 40 to which the electrical wire 22 is fixed is observed, the plurality of protruding pieces 44A, 44B, and 44C are alternately formed on both sides of the band-like portion. The plurality of holding holes 46A, 46B, and 46C formed in the plurality of protruding pieces 44A, 44B, and 44C, respectively, are also alternately formed on both sides of the band-like portion described above. The holding hole may include a hole which is not alternately formed on both sides of the band-like portion described above.

Thus, when the wiring member 20 is fixed to the fixing target member 10 using the vehicle fixing component 50 in the portion where the holding holes 46A, 46B, and 46C described above are formed. Accordingly, the wiring member 20 can be stably fixed to the fixing target member 10. The position of the holding hole in the wiring member is not limited to the above example. The plurality of holding holes may be formed only in a position closer to one side in the first sheet in the wiring member.

According to the wiring member 20 having such a configuration, the vehicle fixing component 50 is held in the second sheet 40 while being inserted into the holding holes 46A, 46B, and 46C of the second sheet 40 having higher rigidity than the first sheet 30. Thus, the vehicle fixing component 50 is fixed to the fixing target member 10 while being firmly held in the second sheet 40 having high rigidity. Thus, the wiring member 20 is fixed to the fixing target member 10 more firmly.

The holding holes 46A, 46B, and 46C are formed in a region in the second sheet 40 with which the first sheet 30 is overlapped. The overlap holding hole 36 is also formed in the same position as that of the holding holes 46A, 46B, and 46C in a region in the first sheet 30 with which the second sheet 40 is overlapped. Thus, the vehicle fixing component 50 passes through the holding holes 46A, 46B, and 46C and the overlap holding hole 36 to be held in both the first sheet 30 and the second sheet 40. As a result, the vehicle fixing component 50 is fixed to the first sheet 30 and the second sheet 40 more firmly. Particularly, the first sheet 30 to which the electrical wire 22 is fixed is fixed to the fixing target member 10 by the vehicle fixing component 50, thus the electrical wire 22 is fixed to the vehicle fixing component 50 more firmly.

The head part 52 of the vehicle fixing component 50 presses the second sheet 40 against the fixing target member 10 while being in contact with the second sheet 40. Thus, the wiring member 20 is firmly fixed to the fixing target member 10. The head part 52 has hardly contact with the holding holes 46A, 46B, and 46C directly, thus a breakage or a fray, for example, hardly occurs in a peripheral edge part of the holding holes 46A, 46B, and 46C in the second sheet 40.

The holding holes 46A, 46B, and 46C are formed in the protruding pieces 44A, 44B, and 44C protruding to an outer side from the band-like portion of the first sheet 30 to which the electrical wire 22 is fixed. Thus, a part of the wiring member 20 other than a portion where the protruding pieces 44A, 44B, and 44C are formed is formed to have a small width. The protruding pieces 44A, 44B, and 44C protrude from the band-like portion, thus the vehicle-side fixing hole 10h is hardly hidden by the band-like portion when the vehicle fixing component 50 is inserted into the vehicle-side fixing hole 10h. Thus, an operation of inserting the vehicle fixing component 50 into the vehicle-side fixing hole 10h can be easily performed while the vehicle-side fixing hole 10h is recognized.

The plurality of holding holes 46A, 46B, and 46C include the holding holes alternately formed on both sides of the electrical wire 22, thus both side portions of the wiring member 20 are fixed to the fixing target member 10 at alternate positions. Accordingly, the wiring member 20 is stably fixed to the fixing target member 10.

The vehicle fixing component 50 includes the columnar part 54 and the plurality of locking pieces 56. Any of the plurality of locking pieces 56 is caught in the holding holes 46A, 46B, and 46C while the vehicle fixing component 50 is inserted into the holding holes 46A, 46B, and 46C, thus suppressed is that the vehicle fixing component 50 comes out of the holding holes 46A, 46B, and 46C. Thus, the vehicle fixing component 50 and the second sheet 40 can be handled integrally and easily.

### Modification Example

Various modification examples are described based on a premise of the embodiment described above.

A holding hole 46A is a first holding hole 46A and a holding hole 46B is a second holding hole 46B in the wiring member 20 in the embodiment described above. A movable amount of the vehicle fixing component 50 in the first holding hole 46A and a movable amount of the vehicle fixing component 50 in the second holding hole 46B may be different from each other in a plane which the second sheet 40 spreads.

The movable amount of the vehicle fixing component 50 in the first holding hole 46A is determined by a difference between a size of the first holding hole 46A and a thickness of the vehicle fixing component 50. In the similar manner, the movable amount of the vehicle fixing component 50 in second first holding hole 46B is determined by a difference between a size of the second holding hole 46B and a thickness of the vehicle fixing component 50. For example, it is assumed that the vehicle fixing component 50 having the same size as the first holding hole 46A and the second holding hole 46B is inserted into each of the first holding hole 46A and the second holding hole 46B. In this case, a magnitude relationship between the movable amount of the vehicle fixing component 50 in the first holding hole 46A and the movable amount of the vehicle fixing component 50 in the second holding hole 46B depends on a magnitude relationship between the size of the first holding hole 46A and the size of the second holding hole 46B.

For example, as illustrated in FIG. 2, an interval between the columnar part 54 and the second holding hole 46B is set to D2 while a center of the second holding hole 46B and a center of the columnar part 54 coincide with each other. It is considered that the locking piece 56 can be deformed until it comes in contact with an outer peripheral surface of the columnar part 54, and D2 described above is the movable amount of the vehicle fixing component 50 in the first holding hole 46A.

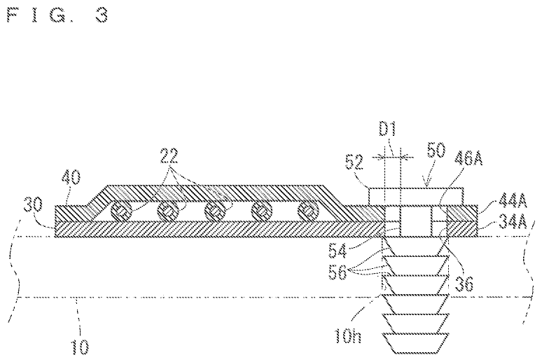

As illustrated in FIG. 3, the first holding hole 46A and the vehicle fixing component 50 are also considered similarly. Herein, a movable amount D1 of the vehicle fixing component 50 in the first holding hole 46A is assumed to be set to be larger than the movable amount D2 of the vehicle fixing component 50 in the second holding hole 46B. In this case, when the first holding hole 46A is formed to be larger than the second holding hole 46B, the interval D1 between the columnar part 54 and the first holding hole 46A is larger than D2 described above. The movable amount can be adjusted by not only the size of the holding hole but also the thickness of the vehicle fixing component.

According to this example, after the vehicle fixing component 50 held in the second holding hole 46B is fixed to the fixing target member 10, the vehicle fixing component 50 held in the first holding hole 46A can be fixed to the fixing target member 10. At this time, the movable amount D2 of the vehicle fixing component 50 held in the second holding hole 46B is small, thus the wiring member 20 is positioned with respect to the fixing target member 10 more accurately by the vehicle fixing component 50. Even in a case where a difference occurs between a positional relationship between the first holding hole 46A and the second holding hole 46B and a positional relationship of plurality of vehicle-side fixing holes 10h into which the plurality of vehicle fixing components 50, which are held in the first holding hole 46A and the second holding hole 46B, are inserted, when the vehicle fixing component 50 is moved within a range of the movable amount D2 described above in the first holding hole 46A, the difference is absorbed.

When the plurality of holding holes 46A, 46B, and 46C are provided, the movable amount of the vehicle fixing component 50 therein may be set to be larger with an increasing distance from any one holding hole based on the movable amount in the one holding hole.

For example, it is applicable that the movable amount of the vehicle fixing component 50 in the holding holes 46A, 46B, and 46C is set to be larger with an increasing distance from the holding hole 46B based on the holding hole 46B in an intermediate portion along the route of the electrical wire 22 in a case where three or more holding holes 46A, 46B, and 46C are provided. In this case, the wiring member 20 can be fixed to the fixing target member 10 based on the intermediate portion along the route of the electrical wire 22 in the wiring member 20. A difference between the positional relationship of the plurality of vehicle-side fixing holes 10h and the positional relationship of the holding holes 46A, 46B, and 46C is absorbed when the vehicle fixing component 50 is moved within a range of the movable amount of mainly the holding holes 46A, 46B, and 46C. At this time, the difference of the positional relationship described above is accumulated with the increasing distance from the holding hole 46B based on the holding hole 46B as the base described above. When the movable amount is set to be larger with the increasing distance from the base position, the vehicle fixing component 50 can be fixed to the fixing target member 10 while absorbing the accumulated difference.

For example, it is applicable that the movable amount of the vehicle fixing component 50 in the holding holes 46A, 46B, and 46C is set to be larger with the increasing distance from the holding hole (for example, the holding hole 46C) based on the holding hole (for example, the holding hole 46C) on any one end portion along the route of the electrical wire 22 in the case where three or more holding holes 46A, 46B, and 46C are provided.

In this case, it is sufficient that, for example, the vehicle fixing component 50 held in the holding hole (for example, holding hole 46C) as the base is firstly fixed to the vehicle-side fixing hole 10h, and subsequently, the vehicle fixing component 50 located away from the base position is fixed to the vehicle-side fixing hole 10h. According to the reason similar to that described above, the wiring member 20 is accurately positioned with respect to the fixing target member 10 more accurately by the vehicle fixing component 50 held in the holding hole (for example, the holding hole 46C) as the base. A difference between the positional relationship of the plurality of vehicle-side fixing holes 10h and the positional relationship of the holding holes 46A, 46B, and 46C is absorbed when the vehicle fixing component 50 is moved within a range of the movable amount of mainly the other holding hole (for example, the holding holes 46A and 46B).

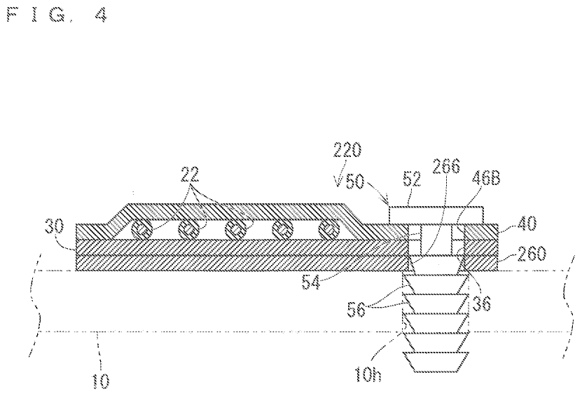

FIG. 4 is a cross-sectional view illustrating a wiring member 220 according to a second modification example. The wiring member 220 has a configuration that a third sheet 260 is additionally provided in the wiring member 20 described above. The third sheet 260 is fixed on an opposite side of the first sheet 30 from the second sheet 40. The third sheet 260 is also a sheet having higher rigidity than the first sheet 30. The third sheet 260 may be formed of the same material as that of the second sheet 40. For example, the second sheet 40 and the third sheet 260 are formed of resin such as polyvinyl chloride (PVC), polyethylene terephthalate (PET), polypropylene (PP), or nylon. The third sheet 260 preferably has the same thickness as the second sheet 40. That is to say, the second sheet 40 and the third sheet 260 may be preferably manufactured by processing the same sheet material.

The third sheet 260 is fixed to the first sheet 30 by welding, bonding, adhesion, or sewing, for example. A fixing position where the third sheet 260 and the first sheet 30 are fixed may be a position located along a side edge portion of the first sheet 30, or may also be the other position. The third sheet 260 may be provided in the same region as the first sheet 30, or may also be provided in a partial region in the first sheet 30. The third sheet 260 is provided in a region overlapped with the second sheet 40. The holding holes 46A, 46B, and 46C in the second sheet 40 are formed in a region overlapped with the third sheet 260. An overlap holding hole 266 is formed in a region overlapped with the forming region of the holding holes 46A, 46B, and 46C in the third sheet 260. It is not necessary to provide the first sheet 30 in the region where the holding holes 46A, 46B, and 46C and the holding hole 266 are formed. For example, it is also applicable that the second sheet and the third sheet protrude to a lateral side from the first sheet, and these sheets have direct contact with each other to be overlapped with each other.

According to the present example, even if the fixing target member, for example, interferes with the first sheet 30 after the wiring member 220 is fixed to the vehicle, the wiring member 220 can be reinforced by the third sheet 260. Rigidity is increased by overlapping the third sheet 260 on the second sheet 40. The holding holes 46A, 46B, and 46C and the holding hole 266 are formed in the portion in which the rigidity is increased. Thus, the vehicle fixing component 50 is firmly held in the portion having high rigidity, and the wiring member 220 is fixed more firmly. The second sheet 40 and the third sheet 260 are formed by the same material, thus a manufacturing cost of the wiring member 20 can be reduced.

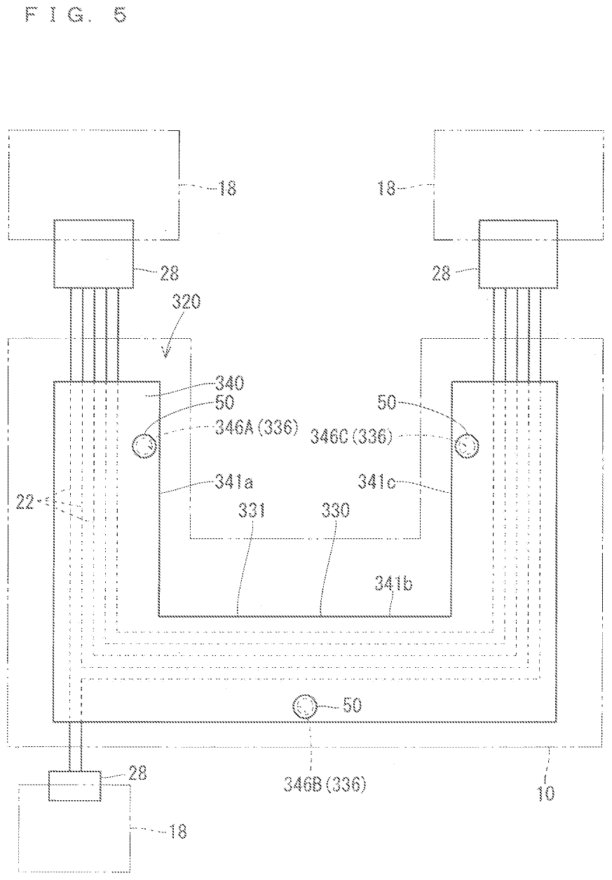

FIG. 5 is a plan view illustrating a wiring member 320 according to a third modification example. In the embodiment described above, the holding holes 46A, 46B, and 46C are formed in the protruding pieces 44A, 44B, and 44C, respectively. In the present modification example, a first sheet 330 corresponding to the first sheet 30 includes a band-like portion 331 to which the electrical wire 22 is fixed. Herein, the band-like portion 331 has a band-like shape following the route of the electrical wire 22, and both side edge portions thereof are also formed into a shape following the route of the electrical wire 22. That is to say, the present modification is different from the embodiment in that the protruding piece is not formed.

A second sheet 340 corresponding to the second sheet 40 includes a portion overlapped with the band-like portion 331 described above. Herein, the second sheet 340 has the same shape as the band-like portion 331 and is overlapped with the whole band-like portion 331. The second sheet may also be partially overlapped with the band-like portion 331 in the first sheet 330. The second sheet may protrude from the first sheet 330. For example, the second sheet may also formed only in a region surrounding the portion of the band-like portion 331 where holding holes 346A, 346B, and 346C are formed.

The holding holes 346A, 346B, and 346C are formed in the portion of the second sheet 340 described above overlapped with the band-like portion 331. Herein, the plurality of holding holes 346A, 346B, and 346C include the holding holes alternately formed on both sides of the electrical wire 22. Herein, the plurality of holding holes 346A, 346B, and 346C are alternately formed on both sides of the electrical wire 22.

More specifically, the holding holes 346B is formed in a position closer to an outer side of an intermediate portion 341B in the second sheet 340. The holding holes 346A and 346C are formed in positions closer to inner sides of both end portions 341a and 341c of the second sheet 340. The holding hole 336 is formed in the same position as the holding holes 346A, 346B, and 346C described above also in the first sheet 330.

According to the present modification example, a portion partially protruding to an edge of the wiring member 320 hardly occurs. Accordingly, the wiring member 20 is hardly caught in a peripheral member at a time of storing, transferring, and assembling the wiring member 20. The wiring member 20 can be fixed near the electrical wire 22.

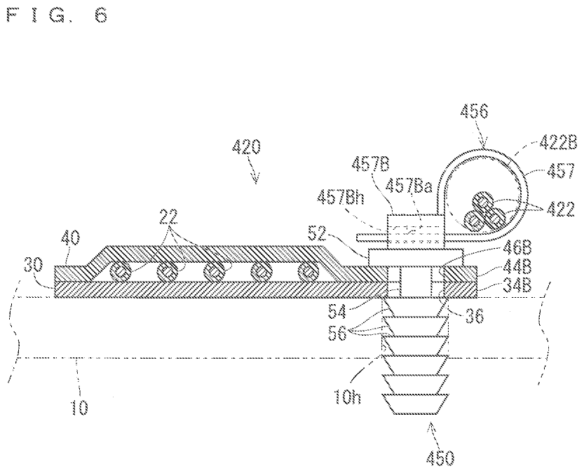

FIG. 6 is a cross-sectional view illustrating a wiring member 420 according to a fourth modification example. In this modification example, a vehicle fixing component 450 corresponding to the vehicle fixing component 50 includes an additional holding part 456.

The additional holding part 456 is a part capable of fixing an additional wire-like transmission member. The additional wire-like transmission member may be a wire-like member transmitting an electrical power or light, for example, in the manner similar to the wire-like transmission member described above. Described herein is an example that the additional wire-like transmission member is an additional electrical wire 422. One or a plurality of additional electrical wires 422 may be provided. Described herein is a case where the plurality of additional electrical wires 422 are bundled into a bundle 422B. FIG. 6 illustrates some bundled additional electrical wires 422.

The vehicle fixing component 450 has a configuration that an additional holding part 456 is integral with the vehicle fixing component 50 in the embodiment described above.

The additional holding part 456 includes a base part 457B integral with the head part 52 and a belt part 457 extending to an outer side from the base part 457B. The belt part 457 is formed into a band-like shape so that it can be wound around the additional electrical wire 422. A plurality of locking grooves are formed on one main surface of the belt part 457 along a longitudinal direction thereof. The locking groove is a groove extending along a width direction of the belt part 457. A through hole 457Bh into which the belt part 457 is inserted is formed in the base part 457B. A locking claw 457Ba which can be locked to the locking groove is formed in the through hold 457Bh. Then, a tip end portion of the belt part 457 is inserted into the through hole 457Bh described above while the belt part 457 is wound around the additional electrical wire 422. The locking claw 457Ba is locked to the locking groove of the belt part 457 in this state, thus kept is the state where the belt part 457 is wound around the additional electrical wire 422. Accordingly, the additional electrical wire 422 is fixed to the vehicle fixing component 450. A component referred to as a clamp with a belt or a clip with a belt used for fixing the wire harness to the vehicle is used as the vehicle fixing component 450.

According to the present example, the vehicle fixing component 450 can fix the additional electrical wire 422 using the additional holding part 456 in addition to the electrical wire 22 fixed to the first sheet 30. For example, the additional electrical wire 422 having a route different from that of the electrical wire 22 fixed to the first sheet 30 can be held by the additional holding part 456. The additional holding part 456 may be fixed to the fixing target member 10 at the same time as the electrical wire 22 fixed to the first sheet 30, or may also be fixed to the fixing target member 10 after fixing the electrical wire 22.

The additional holding part is not limited to the configuration example described above. For example, an elongated plate-like or rod-like elongated portion may be integrally formed as the additional holding part in the head part of the vehicle fixing component. In this case, a banding member such as an adhesive tape or a banding band is wound around the additional electrical wire and the additional holding part while the additional electrical wire is disposed along the additional holding part, thus the additional electrical wire is held by the additional holding part. The present embodiment describes the configuration that the additional holding part is formed in the vehicle fixing component to hold the additional electrical wire, however, this configuration can also be applied to an embodiment described hereinafter. That is to say, it is possible to provide the additional holding hole for fixing the additional holding part in the second sheet and fix the additional holding part to the second sheet via the additional holding hole, thereby fixing the additional electrical wire. As described above, the additional holding part may be provided as a part of the vehicle fixing component or a separated body. When the additional holding part is provided as a separated body, it can also be used so that the second sheet is held on the fixing target member of a vehicle via a vehicle fixing component inserted into the holding hole, and the additional holding hole for fixing the additional holding part is separately provided in the second sheet to fix the additional holding part to the second sheet via the additional holding hole, thereby fixing the additional electrical wire, or also applied is a configuration of fixing the additional electrical wire by a configuration having only the additional holding part and the additional holding hole.

Each configuration described in the embodiment and each modification example can be appropriately combined as long as they are not contradictory. For example, it is also applicable that the wiring member 20 according to the embodiment and the wiring member 320 according to the third modification example illustrated in FIG. 5 are combined, and some of the plurality of holding holes are formed in the protruding pieces and the remaining holding holes are formed in the band-like portion.

### EXPLANATION OF REFERENCE SIGNS

10 fixing target member
10h vehicle-side fixing hole
18 electrical component
20 wiring member
22 electrical wire (wire-like transmission member)
28 connector
30 first sheet
31 intermediate portion
32, 33 end portion
34A, 34B, 34C protruding piece
36 holding hole
40 second sheet
44A, 44B, 44C protruding piece
46A holding hole (first holding hole)
46B holding hole (second holding hole)
46C holding hole
50 vehicle fixing component
52 head part
54 columnar part
56 locking piece
220 wiring member
260 third sheet
266 holding hole
320 wiring member
330 first sheet
331 band-like portion
336 holding hole
340 second sheet
341a end portion
341b intermediate portion
341c end portion
346A, 346B, 346C holding hole
420 wiring member
42d additional electrical wire
422B bundle
450 vehicle fixing component
456 additional holding part
457 belt part
457B base part
457Ba locking claw
457Bh through hole

1. A wiring member, comprising:
a wire-like transmission member;
a first sheet to which the wire-like transmission member is fixed; and
a second sheet, at least a part of which is overlapped with the first sheet, wherein
the second sheet has higher rigidity than the first sheet,
at least one holding hole is formed in the second sheet, and
the second sheet is held on a fixing target member of a vehicle via a vehicle fixing component inserted into the holding hole.

2. The wiring member according to claim 1, wherein
the holding hole is provided in a position away from the wire-like transmission member.

3. The wiring member according to claim 1, wherein
at least the second sheet includes a protruding piece protruding to a lateral side with respect to a portion of the first sheet to which the wire-like transmission member is fixed, and
the holding hole is formed in the protruding piece.

4. The wiring member according to claim 1, wherein
the first sheet includes a band-like portion to which the wire-like transmission member is fixed, and
the holding hole is formed in a part of the second sheet overlapped with the band-like portion.

5. The wiring member according to claim 1, wherein
the holding hole is formed in a portion of the second sheet overlapped with the first sheet,
an overlap holding hole is formed in a region of the first sheet overlapped with a forming region where the holding hole is formed, and
the vehicle fixing component is inserted into both the holding hole and the overlap holding hole.

6. The wiring member according to claim 1, wherein
the plurality of holding holes are formed in the second sheet, and
the plurality of holding holes include holding holes alternately formed on both sides of the wire-like transmission member.

7. The wiring member according to claim 1, wherein
the vehicle fixing member includes a head part extending more than the holding hole, and
the head part has contact with the second sheet while the vehicle fixing component is fixed to the fixing target member.

8. The wiring member according to claim 1, wherein
the vehicle fixing component includes an elongated columnar part and a plurality of locking pieces having a cone-shaped outer peripheral surface, each of which can be caught in a hole formed in the fixing target member, and the plurality of locking pieces are formed at intervals along a longitudinal direction of the columnar part.

9. The wiring member according to claim 1, wherein
the vehicle fixing component includes an additional holding part fixing an additional wire-like transmission member.

10. The wiring member according to claim 1, further comprising
a third sheet fixed to an opposite side of the first sheet from the second sheet, and
the third sheet has higher rigidity than the first sheet.

11. The wiring member according to claim 10, wherein
the holding hole is formed in a portion of the second sheet overlapped with the third sheet, and
an overlap holding hole is formed in a region of the third sheet overlapped with a forming region where the holding hole is formed.

12. The wiring member according to claim 10, wherein
the third sheet is formed of a material identical with the second sheet.

13. The wiring member according to claim 1, wherein
the holding hole includes a first holding hole and a second holding hole, and
a movable amount of the vehicle fixing component in the first holding hole and a movable amount of the vehicle fixing component in the second holding hole are different from each other in a plane which the second sheet spreads.
